(19) United States
(12) Patent Application Publication
(10) Pub. No.: US 2008/0148956 A1
(43) Pub. Date: Jun. 26, 2008

(54) COFFEE MAKER

(76) Inventor: Scott D. Maurer, Rocky River, OH (US)

Correspondence Address: FAY SHARPE LLP, 1100 SUPERIOR AVENUE, SEVENTH FLOOR, CLEVELAND, OH, 44114, US

(21) Appl. No.: 11/614,036

(22) Filed: Dec. 20, 2006

(51) Int. Cl. A47J 31/00

(52) U.S. Cl. 99/287

(57) ABSTRACT

A coffee maker including an assembly for mixing water and coffee during the brewing process is disclosed.

### BACKGROUND

Coffee makers are typically provided with a filter basket that receives a coffee filter, ground coffee and water. The filter basket includes an outlet opening disposed approximately in the center of the basket. Hot water is introduced into the top of the filter basket, which at this time has ground coffee disposed therein, and exits through the outlet opening as a beverage, typically referred to simply as coffee.

Typically the water is introduced into the middle region of the filter basket moistening the central region of the ground coffee first and wetting the peripheral regions of the ground coffee later. To provide for a tastier beverage, mixing apparatuses are known, for example in U.S. Pat. No. 4,779,520 and U.S. Pat. No. 4,983,412, to mix the water and coffee grounds in the filter basket. Known mixing apparatuses have certain shortcomings.

### BRIEF DESCRIPTION

Coffee makers that can be used to make a small serving of coffee, e.g. a single serving, as well as many cups of coffee are disclosed. These coffee makes may be referred to as a personal coffee maker, a household coffee maker, and a commercial coffee maker. An example of one such coffee maker includes a filter basket, a motor, a hub, and a mixing blade. The hub operatively connects to the motor and is configured to rotate about a rotational axis when driven by the motor. The mixing blade connects to the hub for pivotal movement into a use position where the mixing blade is disposed for rotational movement within the filter basket. When in the use position, the mixing blade can stir the ground coffee and water mixture in the filter basket during the brewing process.

An example of a coffee maker that can be typically used to make a small amount, e.g. a single serving, of coffee includes a filter basket, a mixing assembly, and a frame. The filter basket holds water and coffee grounds and includes an outlet through which brewed coffee exits the filter basket. The mixing assembly mixes the water and coffee in the filter basket. The mixing assembly includes a mixing blade and a motor. The mixing blade operatively connects to the motor such that the motor drives the mixing blade. The mixing blade is located with respect to the filter basket such that the mixing blade moves within the filter basket to mix the water and coffee as the motor drives the mixing blade. The frame supports the filter basket and is configured to be at least partially supported by a coffee cup. The frame includes an opening to allow the brewed coffee to exit the filter basket en route to the coffee cup.

A device for making coffee can include a filter basket, a motor, a movable mixing blade, and a movable water distributor. The filter basket holds water and coffee grounds and includes an outlet through which brewed coffee exits the basket. The mixing blade operatively connects to the motor and is positioned such that the mixing blade moves within the filter basket as the motor is driven. The water distributor delivers water to the filter basket. The water distributor operatively connects to the motor and includes an outlet that moves as the motor is driven.

An example of a coffee maker includes a motor, a mixing blade, and a filter basket. The mixing blade connects to the motor and is selectively disposed in the filter basket for movement in the filter basket when being driven by the motor. The filter basket includes an inlet that is in communication with the ambient vertically above the filter basket. This allows a user of the coffee maker to pour water into the filter basket while the mixing blade is disposed in the filter basket.

Another example of a coffee maker includes a filter basket, a mixing assembly, a battery compartment, and electrical contacts. The filter basket holds water and coffee grounds and includes an opening through which brewed coffee exits the filter basket. The mixing assembly is used to mix the water and coffee grounds in the filter basket. The mixing assembly includes a mixing blade and a motor. The mixing blade operatively connects to the motor such that the motor drives the mixing blade. The mixing blade is also selectively located within the filter basket to mix the water and coffee grounds as the motor drives the mixing blade. The battery compartment connects to the filter basket. The electrical contacts are disposed in the battery compartment and are in electrical communication with the motor.

### BRIEF DESCRIPTION OF THE DRAWINGS

FIG. 1 is a cross-sectional view of an embodiment of a coffee maker supported on a conventional coffee cup.

FIG. 2 is a cross-sectional exploded view of the coffee maker depicted in FIG. 1.

FIG. 3 is a cross-sectional view of another embodiment of a coffee maker.

FIG. 4 is a cross-sectional view of an upper portion of an alternative embodiment of a coffee maker that includes components similar to the coffee maker depicted in FIGS. 1 and 2.

FIG. 5 is a cross-sectional view of an upper portion of another alternative embodiment of a coffee maker that includes components similar to the embodiment depicted in FIGS. 1 and 2.

FIG. 6 is a cross-sectional view of another alternative embodiment of an upper portion of a coffee maker that includes components similar to the embodiment depicted in FIGS. 1 and 2. This coffee maker includes a lever shown in a first position.

FIG. 7 is a cross-sectional view of the coffee maker depicted in FIG. 6 with the lever shown in a second position.

FIG. 8 is a cross-sectional view similar to FIG. 6; however, this embodiment includes a knob to move an interlock mechanism and a mixing assembly. The knob is shown in a first position.

FIG. 8A is a front view of the knob of FIG. 8 engaging a portion of the interlock mechanism.

FIG. 9 is a cross-sectional view similar to FIG. 8 with the knob depicted in a second position.

FIG. 10 is a cross-sectional view similar to FIGS. 6 and 8; however, this embodiment includes a solenoid and switch assembly to move an interlock mechanism and mixing assembly. The solenoid is shown in a first position.

FIG. 11 is a cross-sectional view similar to FIG. 10 with the solenoid depicted in a second position.

### DETAILED DESCRIPTION

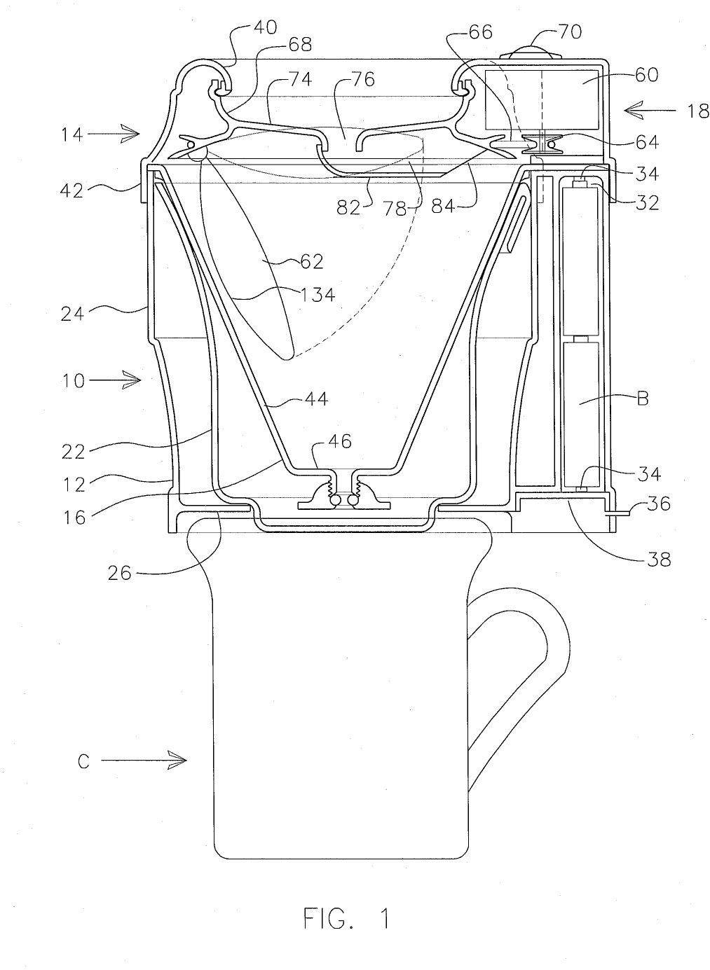

With reference to FIG. 1, an embodiment of a coffee maker 10 includes a housing (or base) 12, a lid 14, a filter basket 16, a mixing assembly 18, and a heating cup 22. In the embodiment depicted in FIG. 1, the coffee maker 10 is configured to rest on a conventional coffee cup C. The conventional coffee cup C shown can have a diameter of about three inches and a height of about three and ¾″. These dimensions can change where the diameter can be in the range of about two inches to about five inches and the height can be in the range of about two inches to about five inches. Moreover, the diameter of the cup C need not be constant. This coffee maker 10 can allow a person to make a single serving of coffee while still allowing the person to use a conventional coffee filter and conventional coffee grounds. Other embodiments will be described where the coffee maker does not rest on a coffee cup and the invention is not limited to coffee makers that rest on a cup. The embodiment depicted in FIG. 1 will typically be used to make a single serving, e.g. 8-20 fluid ounces, of coffee; however, this is not required.

The housing 12 is made of a rigid material, for example, plastic or metal. In the depicted embodiment, the housing 12 supports the filter basket 16, mixing assembly 18 and other components of the coffee maker, which will be described below. It includes a generally cylindrical outer side wall 24 and a lower wall 26 that can rest on the coffee cup C. The lower wall 26 extends generally inwardly from and perpendicular to the outer side wall 24 so that the housing 12 and other components of the coffee maker 10 can be supported by the upper rim of the coffee cup C.

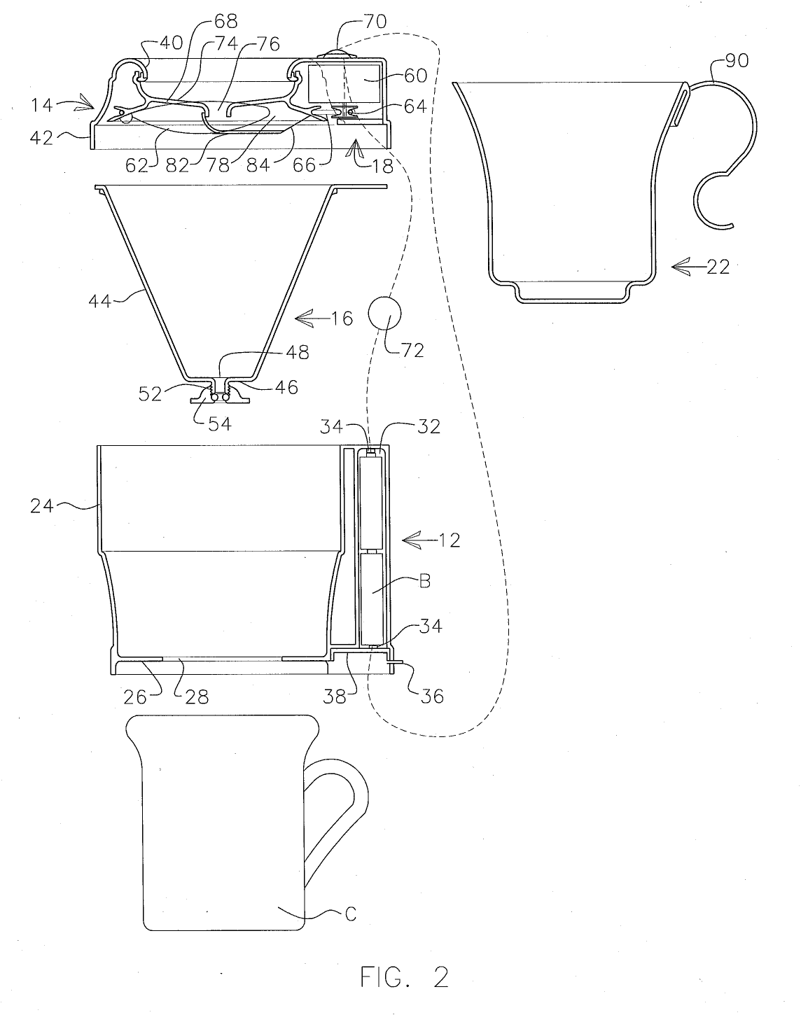

The lower wall 26 is ring-shaped to define a circular opening 28 (FIG. 2) through which brewed coffee passes into the coffee cup C in a manner that will be described in more detail below. The lower wall 26 defines a support ledge that rests on the upper rim of the coffee cup as shown in FIG. 1. The height that the outer side wall 24 extends above the lower wall 26 is function of the filter received in the filter basket 16 whether the filter be a conventional No. 1 cone filter, a conventional No. 2 cone filter, a conventional No. 4 cone filter, a conventional No. 6 cone filter, a conventional 8-12 cup basket filter and/or a reusable equivalent of any of the aforementioned filters. A filter basket 16 configured to accommodate a cone-type filter is shown; however, as described above, the filter basket can take other configurations which will be described in more detail below. A portion of the outer side wall 24 can also extend below the lower wall 26 to provide a locating mechanism to facilitate locating the coffee maker onto the coffee cup.

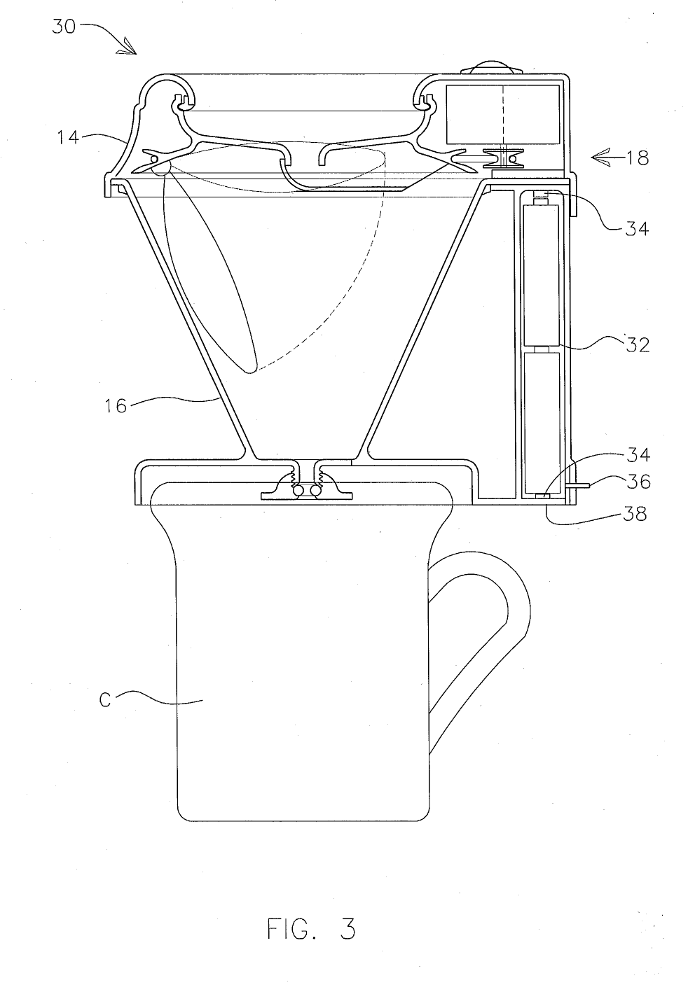

Instead of the housing described above, the coffee maker can include a frame that is configured to be at least partially supported on the coffee cup. In this embodiment the frame can include a support ledge that rests on the coffee cup, but it may not include a side wall configured to entirely enclose the filter basket. The support ledge would be configured to allow brewed coffee to pass from the filter basket into the coffee cup. Many different structures can be provided to support the filter basket and other components of the coffee maker. For example, FIG. 3 depicts an example of a coffee maker 30 having a frame or housing that is differently configured than the coffee maker shown in FIG. 1. This example of a coffee maker can still include the lid 14, filter basket 16 and mixing assembly 18 found in the embodiment depicted in FIGS. 1 and 2. In the embodiment depicted in FIG. 3, the filter basket 16 is connected to a support ledge, which is similar to the support ledge 26 depicted in FIGS. 1 and 2. If desired, the filter basket and the support ledge can be formed as a single piece or component. Accordingly, the terms “housing” and “frame” are not limited to only the structures depicted in the drawings and particularly described herein.

In the embodiment depicted in FIGS. 1 and 2, the housing 12 also includes a battery compartment 32. Contacts 34 are disposed in the battery compartment and batteries B, for example AA batteries, can be provided in the battery compartment to provide power for the mixing assembly 18 in a manner that will be described in more detail. A recharging jack 36 can also be provided that is in electrical communication with the batteries. Known electronics can be provided so that rechargeable batteries can be used. A removable panel 38 selectively connects to the housing 12 so that access is provided to the battery compartment 32. Alternatively, access can be provided to the battery compartment 32 by removing the lid 14 and the filter basket 16. The battery compartment 32, contacts 34, recharging jack 36 and panel 38 can also be provided with the embodiment shown in FIG. 3.

The lid 14 rests on the housing 12. The lid includes a circular opening 40 through which water is introduced into the filter basket 16. The opening 40 has a diameter that is about equal to a diameter of conventional coffee cup, which facilitates pouring heated water into the coffee maker 10. The opening 40, and thus the filter basket 16, is in communication with the ambient above the coffee maker 10. The coffee makers 10 and 30 depicted in FIGS. 1-3 will typically be used where a user pours heated water directly into the coffee maker. Accordingly, these embodiments can lack a heating element to heat the water, which makes battery power an attractive energy source because the batteries do not have to provide energy to a heating element. The lid 14 is funnel-shaped towards a central axis of the circular opening 40. Similar to the housing 12, the lid 14 can also be made from a rigid, durable material, such as plastic or metal. The lid 14 also includes an apron 42 that acts as a locating mechanism that surrounds the housing 12 (see FIG. 1) when the lid is placed on the housing.

The filter basket 16 is received inside the housing 12. In the depicted embodiment, the filter basket 16 is shown as having a conical side wall 44 and a planar lower wall 46. The lower wall 46 includes an outlet opening 48 that is aligned with an axis of symmetry of the conical side wall 44. A threaded boss 52 depends downwardly from the lower wall 46 surrounding the outlet opening 48. An adjustable valve assembly 54 attaches to the boss 52 to control the volume of liquid, i.e. coffee, that exits the filter basket over a specified period of time. The outlet orifice of the valve assembly 54 can be changed in diameter in a manner that is known in the art.

As discussed above the filter basket 16 can take a number of different configurations—the configuration of the filter basket typically being a function of the type of filter that is to be received in the filter basket. Alternatively, the filter basket can include a filter disposed in or over the outlet opening 48 to preclude coffee grounds from leaving the filter basket and passing through to the coffee cup.

The mixing assembly 18 mixes the water and coffee ground mixture in the filter basket 16 during the brewing process. In the depicted embodiment, the mixing assembly 18 includes a motor 60 that drives a mixing blade 62. In the depicted embodiment, the motor is a known battery powered DC motor. The motor 60 is electrically connected to the controls 34 in the battery compartment via circuitry (depicted schematically).

In the depicted embodiment, the mixing blade 62 is a flat, thin, flexible piece of plastic. The mixing blade, however, is not limited to such a configuration but instead includes elements that may not be flat and thin. The term “mixing blade” is meant to include any element that can be used to mix or blend the coffee grounds and water. Moreover, the mixing blade can be made from materials other than plastic. In the depicted embodiment, the motor 60 drives the mixing blade 62 (only one is depicted, but a plurality can be provided) such that the mixing blade orbits about the central axis of the conical side wall 44 of the filter basket 16. Alternatively, the mixing blade can be operatively connected to the motor via a transmission that translates the rotational movement generated by the motor into a linear movement of the mixing blade whether the linear movement is in a horizontal or vertical direction. Also, if linear movement of the mixing blade is provided, a solenoid can be used to drive the mixing blade.

More specific to the embodiment disclosed in FIGS. 1 and 2, the motor drives a pulley 64. An endless belt 66 wraps around the pulley 64 and a hub 68. The mixing blade 62 attaches to the hub 68. The diameter of the hub 68 is much greater than the diameter of the pulley 64. This reduces the rotational speed of the mixing blade 62 as compared to the rotational speed of the pulley. The motor 60 receives power from the batteries B. More particularly, a button 70, which operates a switch (not shown), controls the delivery of power between the contacts 34 in the battery compartment 32 and the motor 60. A timing device 72 (schematically depicted in FIG. 2) can be provided in the circuit between the batteries B and the motor 60. The timing device can be a solid state timing device that opens the circuit between the batteries B and the motor after a predetermined amount of time so that the mixing action ceases.

The hub 68 connects to the lid 14 and the motor 60 is also mounted in the lid 14. The hub 68 includes a funnel-shaped upper surface 74 that leads towards an inlet opening 76. The inlet opening 76 leads towards a passage 78 of a water distributor 82. The water distributor 82 includes an outlet opening 84 that rotates along with the hub 68 and thus the mixing blade 62. In the embodiment depicted in FIGS. 1 and 2, the hub 68 and the water distributor 82 are an integrally formed piece of plastic and/or metal. Alternatively, these components can be separate components that are connected to one another so that the outlet opening 84 of the water distributor 82 can rotate when the hub is rotated. The water distributor 82 directs water towards the conical side wall 44 of the filter basket 16, thus first wetting the periphery of the coffee grounds found in the filter basket.

The lid 14 has the wide circular opening 40 which allows the user of the coffee maker 10 to view the rotation of a majority of the hub 68 as it is driven by the motor. This also provides a wide target for the user to pour water into the coffee maker. The mixing blade 62 attaches to the hub 68 at a location offset from a rotational axis of the hub, which is aligned with the axis of symmetry of the conical side wall 44 of the filter basket 16. Such a configuration provides for more disturbance of the coffee and water mixture in the filter basket as compared to a mixing blade that attaches to a rotating member that is coaxial with the symmetrical axis of the filter basket. In other words, less rotational speed and movement need be generated by the motor 60 to provide adequate mixing of the coffee grounds and water mixture. Additionally, the belt 66 and pulley 64 mechanism that attaches to the hub 68 provides for a quieter transmission for driving the mixing blade 62 and the water distributor 82 as compared to a transmission that includes gears. Nevertheless, the motor 60 can drive the mixing blade 62 through a transmission including a gear or a plurality of gears without departing from the scope of the invention.

The mixing blade 62 pivots into and out of the lid 14 and into and out of the filter basket 16. If desired, the mixing blade can move with respect to the hub 68 in another manner, e.g. a sliding movement. As more clearly seen in FIG. 1, the mixing blade 62 can move from a retracted position to an extended position. When in the extended position the mixing blade 16 is at an angle with respect to the rotational axis of the hub 62 and is generally parallel to the angle of the conical side wall 44 with respect to its axis of symmetry. The outermost edge (with respect to the rotational axis) of the mixing blade 134 that is closest to the conical side wall 44 of the filter basket 16 is offset from the side wall so that the blade does not contact the side wall or a filter received in the filter basket. The lowermost end of the blade is also offset from the lower wall 46. In the retracted (storage) position, the mixing blade is folded into the lid 14 for storage so that its lowest point is disposed above the lower edge of the apron 42. When in the retracted position the lid 14 can be placed onto a countertop or other surface without the mixing blade getting in the way while, for example, the user of the coffee machine places the coffee grounds into the filter basket 16.

As discussed above, the mixing blade 62 can be made from a flexible material so that if the lid 14 is placed onto the counter while the mixing blade is in the extended position, then the mixing blade can bend or flex and not result in permanent damage to the mixing blade. A flexible mixing blade is also useful in situations when the dry coffee grounds that are placed into the filter basket 16 come up to a level that is above the lowermost end of the mixing blade when it is in its extended position. The flexible mixing blade can then bend so that the lid 14 can be properly placed onto the housing 12 in preparation for brewing. The mixing blade 62 can attach to the hub 68 via a ball and socket type connection to allow a wide range of pivotal motion for the mixing blade should it contact the counter when being stored or contact dried or wet coffee grounds inside of the filter basket 16. A biasing member, e.g. a spring or springs, can be provided to bias the mixing blade 62 toward the retracted position and/or the extended position. A thin, flat mixing blade can also be useful to slice through dried coffee grounds that are placed into the filter basket 16 prior to the brewing process and can also be more easily cleaned as compared to a mixing element having a more complex configuration. The mixing blade, however, can have a more complex configuration if desired. The mixing blade can also be configured and disposed in the housing in a manner so that its lower end is offset above the wet grounds of coffee at the end of the brewing cycle to allow for easy cleaning and removal of the blade after the brewing cycle.

A heating cup 22 is also provided with the coffee maker 10 described in FIGS. 1-2. As more clearly seen in FIG. 1, the heating cup 22 can be received inside the housing 12 between the cylindrical side wall 24 of the housing and the filter basket 16 to provide for easy packaging and shipment of the coffee maker. The heating cup 22 includes a resilient handle 90 that bends when received inside the housing 12 as seen in FIG. 1. The heating cup 22 is made from a material that can be heated in a microwave.

To brew coffee using the coffee maker depicted in FIGS. 1 and 2, the heating cup 22 is removed from the housing 12 and filled with water. The heating cup 22 filled with water is then placed into a microwave oven to heat the water. The water can also be heated in other manners, which may obviate the need for a heating cup.

A conventional coffee filter can be placed into the filter basket 16. Alternatively, the filter basket 16 can include a filtering mechanism that limits the ability of ground coffee to exit the outlet 48 and move into the coffee cup. Coffee grounds are then placed into the filter basket 16 and the filter basket is placed into the housing 12. The lid 14 is then placed onto the housing. The button 70 is pushed to provide power to the motor 60 so that the mixing blade 62 moves along with the outlet 84 of the water distributor 82. Water is then poured onto the upper surface 74 of the hub 68 and is dispersed towards the outer side wall 44 of the filter basket 16 and the mixing blade 62 mixes the coffee and water mixture in the filter basket. Brewed coffee exits the filter basket 16 through the outlet opening 48 and the valve 54 and travels towards the coffee cup C resulting in a brewed cup of coffee. The mixing operation can be stopped by pressing again the button 70, or it can be automatically stopped by the timing mechanism 72.

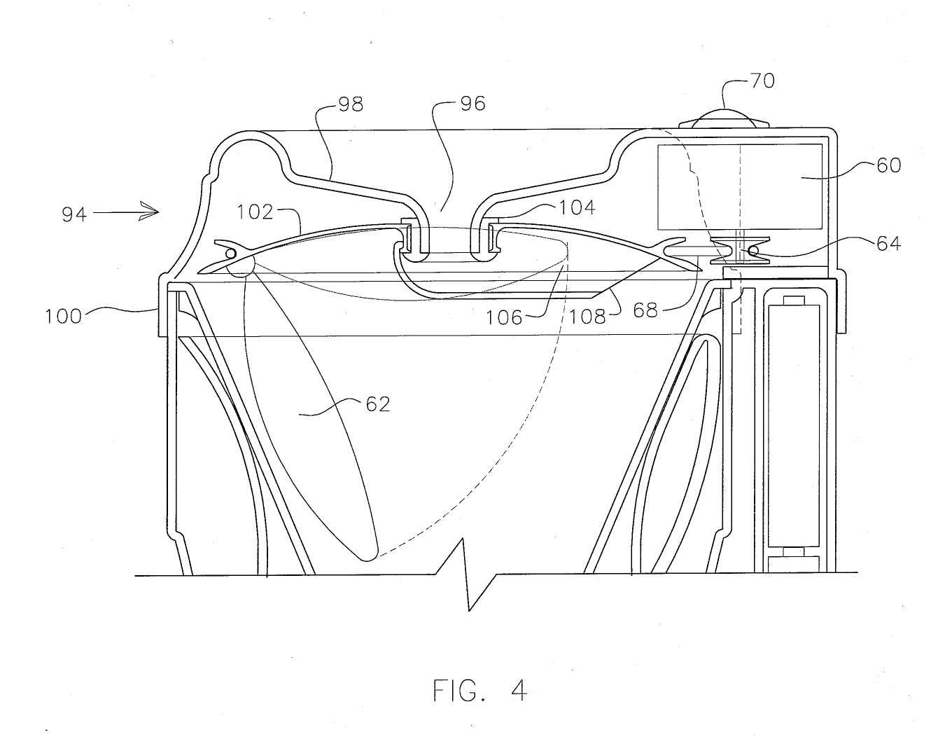

With reference to FIG. 4, an alternative embodiment of an upper portion of a coffee maker that can rest on top of the housing disclosed in FIGS. 1-3 is shown. For ease of explanation, components of this alternative that are the same as the components already described with reference to FIGS. 1-3 will be given the same reference number that was used with reference to FIGS. 1 and 2. In this embodiment, a lid 94, which is similar to the lid 14 in FIGS. 1 and 2, includes a smaller inlet opening 96 when compared to the inlet opening 40 of the lid 14 in FIGS. 1 and 2. The lid 94 also includes an upper surface 98 that funnels towards the inlet opening 96 and an apron 100, which is similar in size and function to the apron 42 of the lid 14.

A hub 102, which is similar to the hub 68 disclosed in FIGS. 1 and 2, attaches to the lid 94 and rotates about a rotational axis that is generally aligned with an axis of symmetry of the inlet opening 96 and a filter basket (not shown in FIG. 3 but similar to filter basket 16 in FIGS. 1 and 2). The hub 102 includes a hollow boss 104 that connects to the lid 94. Similar to the hub 68 disclosed in FIGS. 1 and 2, the hub 102 also operates as a water distributor in that it includes a passage 106 that leads to an outlet opening 108. Alternatively, the hub 102 and the water distributor can be separate components. In such a configuration the outlet of the water distributor can, if desired, rotate if the water distributor is operatively connected to the motor.

The hub 102 is driven by a motor 60 that drives a pulley 64 having an endless belt 66 wrapped around the pinion and the periphery of the hub 102. A button 70 operates a switch that selectively delivers power to the motor 60 via batteries that are found in a battery compartment (similar FIGS. 1 and 2). A blade 62 pivotally attaches to the hub 102 in the same manner as was described with reference to FIGS. 1 and 2.

With reference to FIG. 5, an alternative embodiment of the coffee maker 110 is disclosed. This coffee maker is similar to those typically found in households and it includes a housing 112 (only a portion of which is shown), a lid 114, and a filter basket 116. Only an upper portion of the coffee maker 110 is depicted in the figures, since the lower portion of the coffee maker is similar to and can be the same as known coffee makers. The coffee maker 110 depicted in FIG. 5 also includes the mixing assembly 118 which is similar to the mixing assemblies disclosed with reference to FIGS. 1-4.

A water reservoir 122, into which a user of the coffee maker pours water prior to the brewing process that will eventually mix with coffee grounds that are poured into the filter basket 116, is disposed in the housing 112. A tube 124, or similar passage, provides a path for heated water to travel from the reservoir 122 towards the filter basket 116.

The filter basket 116 depicted in FIG. 5 includes a conical side wall 144 that is symmetrical about an axis. The depicted filter basket 116 is configured to receive a conventional cone-shaped filter, similar to the filter basket 16 described with reference to FIGS. 1-3. Alternatively, the filter basket 116 can take other configurations, for example, the filter basket can be configured to accommodate a basket type filter. Filter basket 116 can also be similar to the filter basket 16 depicted in FIGS. 1-3 in that it includes an outlet and can also include and an adjustable discharge valve. The filter basket can also include other filtering mechanisms to preclude coffee grounds from traveling from the filter basket into a coffee pot.

The lid 114 attaches to the housing 112 at a hinge 130 so that the lid 114 and the components attached to the lid, which will be described in more detail below, pivotally move with respect to the housing 112. The lid 114 includes a generally horizontal upper wall and a generally vertical side wall to define a housing in which the components of the mixing assembly 118 are housed.

The mixing assembly 118 generally includes a motor 132 and a mixing blade 134 that is operatively connected to the motor for rotational movement therewith. In the depicted embodiment, the motor 132 attaches to the mixing blade 134 via a belt type transmission which provides a very quiet driving mechanism for the mixing blade which may be desirable since coffee is often made in the morning when one is waking up. Nevertheless, the motor 132 can connect to the mixing blade 134 via alternative transmissions that include gears and the like. In the depicted embodiment, the motor 132 drives a first pulley 136 which drives a belt 138 that is wrapped around a second pulley 142. The diameter of the second pulley 142 is much greater than the diameter of the first pulley 136 which reduces the rotational speed at which a pulley shaft 144, which is attached to the second pulley 142, rotates. The pulley shaft 144 connects to a hub 146 to which the mixing blade 134 attaches. The hub 146 also acts as a water distributor, which will be described in more detail below.

Similar to the embodiments depicted in FIGS. 1-3, the mixing blade 134 attaches to the rotating hub 146 at a location that is offset from the rotational axis of the rotating hub 146. The mixing blade 134 pivotally attaches to the hub 146 for movement into and out of the filter basket 116 as well as into and out of the lid 114. When in the extended position, the central axis of the mixing blade 134 is generally parallel to the conical side wall 144 of the filter basket 116. Also, the outermost edge (with respect to the rotational axis) of the mixing blade 134 that is closest to the side wall 144 of the filter basket 116 is offset from the side wall so that the mixing blade does not contact the side wall or a filter that is received inside the filter basket. The lowermost end, i.e. the distal end as compared to the rotating hub 146, of the mixing blade 134 is offset from the lowermost surface of the filter basket 116. When in the retracted position, at least a majority of the mixing blade 134 is disposed in the lid 114. A lower surface of the hub 146 can include a surface having a configuration that complements the configuration of the mixing blade 134. For example, as seen in FIG. 5, the lower surface of the hub 146 has a curved surface that complements the curved edge of the mixing blade 134.

In the depicted embodiment, the mixing blade 134 is made of a very flexible (typically plastic) thin material and attaches to the rotating hub 146 via a ball and socket type arrangement. Similar to the mixing blade 62 that is described above, the mixing blade 134 in the embodiment is not limited to a flat and thin configuration. Even though the mixing blade 134 is movable between at least two positions, the coffee maker can be configured to allow for opening of the lid 114 while the mixing blade 134 is in the extended position.

As discussed above, the rotating hub 146 also acts as a water distributor. As discussed with regard to the above described embodiments, the hub and the water distributor can be separate components. Hot water travels through the hot water tube 124 towards a stationary cylinder 152 found in the lid 114. In the depicted embodiment, the stationary cylinder 152 depends from an internal wall 154 in the lid 114 that separates the belt drive transmission of the mixing assembly 118 from the motor 132 and the water distributor, which in the depicted embodiment is the hub. The stationary cylinder 152 includes an opening 156. The hub 146 includes cylindrical boss 158 that engages and rotates with respect to the stationary cylinder 152 when the hub is driven by the motor 132. Water passes from the hot water tube 124 and travels towards a water distributor surface 160 formed in the hub 146, into a passage 162 and out an outlet 164. The outlet 164 rotates along with the mixing blade 134 as both are rotated by the motor 132. The water outlet 164 directs water towards the conical side wall 144 of the filter basket 116 thus wetting the periphery of the coffee grounds.

The mixing assembly 118 can be operated by the switch that operates the coffee maker 110. The motor 132 receives power from the source (typically AC) that powers the other components of the coffee maker. A timing device, similar to the timing device 72 described above, can be provided in the coffee maker to control the amount of time that power is delivered to the motor.

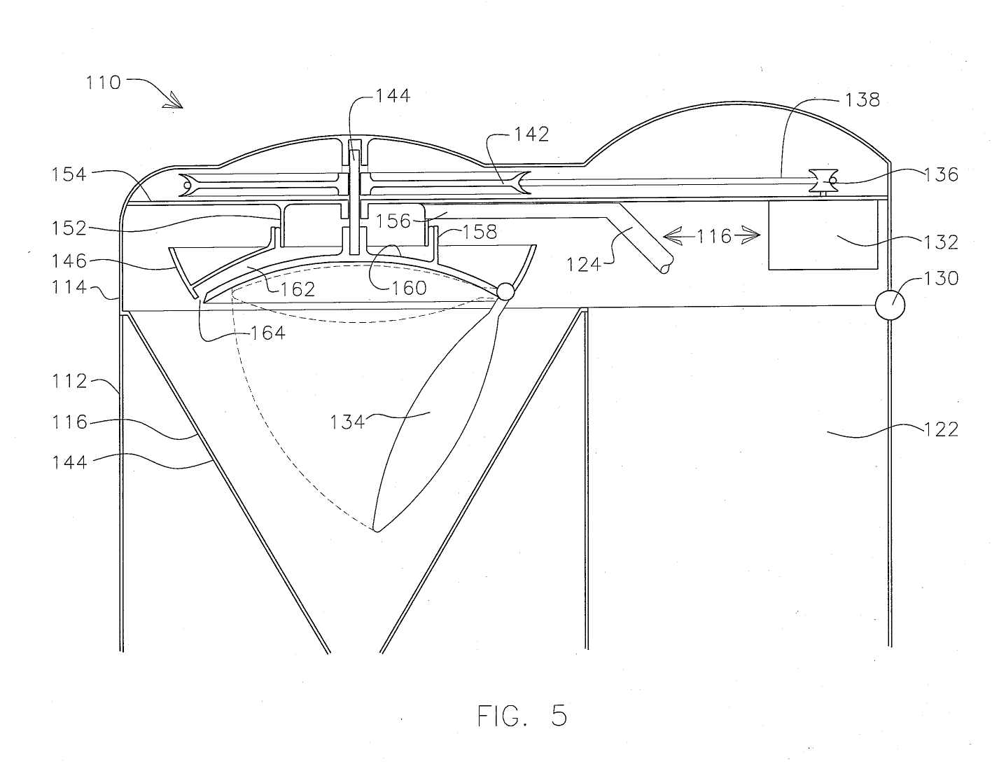

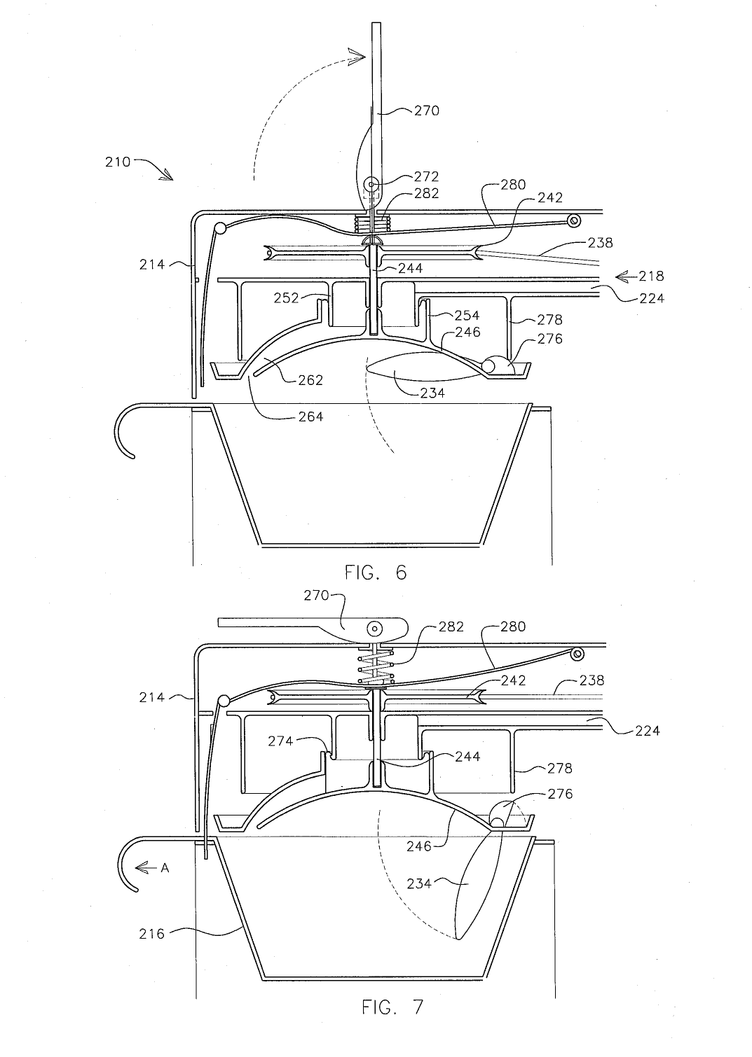

With reference to FIG. 6, in an upper portion of a coffee maker 210, which is similar to a commercial-type coffee maker or a household coffee maker having a slide-out filter basket, includes a housing (not depicted), a lid 214, and a filter basket 216 (FIG. 7). Only a portion of the coffee maker 210 is particularly described since the other components are the same as or very similar to a conventional coffee maker. The coffee maker depicted in FIGS. 6 and 7 also includes a mixing assembly 218 that is very similar to the mixing assembly 118 described with reference to FIG. 5. The mixing assembly includes a motor (not depicted) that drives a belt 238 that is wrapped around a first pulley (not shown) and a second pulley 242. The second pulley 242 attaches to a pulley shaft 244 at an upper end and the pulley shaft attaches to a hub 246 at its lower end. A mixing blade 234, which is similar to the mixing blades described above, attaches to the rotating hub 246 at a location offset from a rotational axis of the rotating hub. The rotating hub 246 also acts as a water distributor similar to the embodiments described above. As discussed with regard to the above described embodiments, the hub and the water distributor can be separate components. Hot water is delivered via a hot water tube 224 to a stationary cylinder 252 and then to the water distributor (hub) 246. Similar to the embodiment described in FIG. 5, the hub 246 includes a cylindrical boss 254 that engages and rotates with respect to the stationary cylinder 252. The water distributor includes a passage 262 that leads to an outlet 264 that rotates along with a mixing blade 234.

In the embodiment depicted in FIGS. 6 and 7, the filter basket 216 is removed from the coffee maker by sliding the filter basket out of the coffee maker similar to conventional commercial-type coffee machines. The coffee maker depicted in FIGS. 6 and 7 includes an external mechanism which allows for the mixing blade 234 to move between an extended position and a retracted (storage) position. Examples of such mechanisms include a knob, a button and a lever. In the extended position, the mixing blade 234 is located in the filter basket 216. In the retracted position, the mixing blade 234 is located above the filter basket 216 so that the filter basket can be removed from the coffee maker.

More particular to the embodiment disclosed in FIGS. 6 and 7, a lever 270 mounts to the lid 214 and is movable between a first position, which results in the mixing blade 234 being disposed above the filter basket 216 (see FIG. 6) and a second position which results in the mixing blade 234 being disposed in the filter basket 216 for mixing the contents of the filter basket during the brewing process. If desired, the lever 270 can also operate an electrical switch (not shown) which can begin the brewing process along with the mixing process. The electrical switch can be electrically connected to a heater/water delivery system, which begins the brewing process.

The lever 270 attaches to the drive shaft 244 at a hinge 272. Movement of the lever 270 from first position (FIG. 6) into the second position (FIG. 7) results in the hub 246 moving downwardly towards the filter basket 216. A slip seal 274 can be provided between the stationary cylinder 252 and the cylindrical boss 254 of the rotating hub 246 to discourage any water from traveling between the two and encourage the water to travel towards the outlet opening 264. Different than the mixing blades described above, the mixing blade 234 in the embodiment depicted in FIGS. 6 and 7 includes a cam surface 276 that cooperates with a lever 278 that is formed in the lid 214. In the depicted embodiment, the lever 278 is a cylindrical member that is formed in the lid 214 and is stationary so that no matter the location of the mixing blade 234 at the end of the brewing cycle, the lever 278 can contact the cam surface 276 of the mixing blade 234 to retract the mixing blade from the filter basket 216. As seen when comparing FIGS. 6 and 7, when the lever 270 is moved into the open position (FIG. 6), the cam surface 276 of the mixing blade 234 is drawn towards the lever 278 to contact the cam surface such that the cam surface rides along the lever and the mixing blade 234 pivots out of the filter basket 216 and towards the rotating hub 246.

The coffee maker 210 depicted in FIGS. 6 and 7 can also include an interlock mechanism to preclude the accidental removal of the filter basket 216 from the coffee maker while the mixing blade 234 is disposed inside the filter basket. The lever 270 can also move an L-shaped structure 280 that precludes the removal of the filter basket 216 in a direction of arrow A as depicted in FIG. 7. A spring 282 surrounds the shaft 244 and contacts the lid 214 to bias the L-shaped structure 280 downwardly when the lever 270 is in the closed position. Even though an interlock mechanism is provided, the mixing blade 234 can also be made from a very flexible material and attach to the rotating hub 246 via a ball and socket type of arrangement so that if there is accidental movement of the filter basket 216 in the removal direction the mixing blade 234 is not permanently damaged if it were to contact the filter basket.

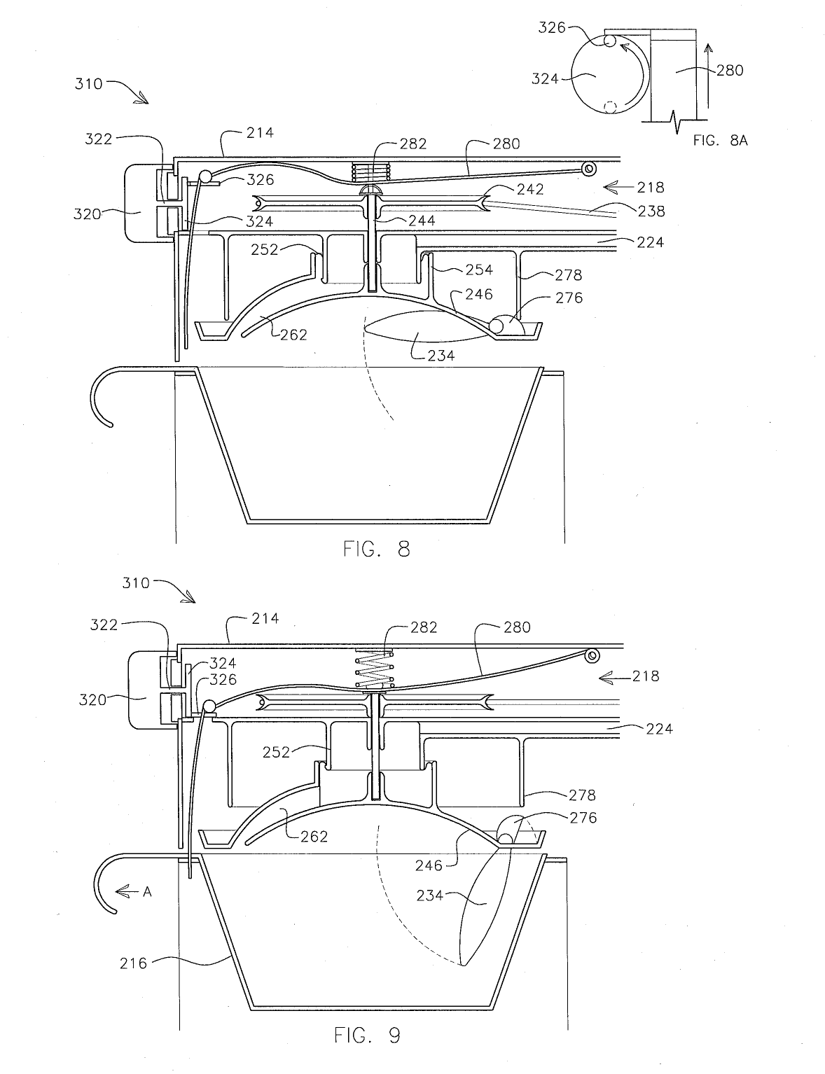

With reference to FIG. 8, an upper portion of a coffee maker 310, which is similar to the embodiment depicted in FIGS. 6 and 7, includes a knob 320 to move the mixing blade 234. This embodiment of a coffee maker still includes a housing (not depicted), a lid 214, and a filter basket 216 (FIG. 9) similar to the embodiment depicted in FIGS. 6 and 7. Only a portion of the coffee maker 310 is particularly described since the other components are the same as or very similar to a conventional coffee maker. The coffee maker 310 also includes a mixing assembly 218 that includes the motor (not depicted) that drives the belt 238 that is wrapped around a first pulley (not shown) and a second pulley 242. The second pulley 242 attaches to the pulley shaft 244 at an upper end and the pulley shaft attaches to the hub 246 at its lower end.

More particular to the embodiment disclosed in FIGS. 8 and 9, the knob 320 mounts to the lid 214 and is movable, e.g. rotatable, between a first position, which results in the mixing blade 234 being disposed above the filter basket 216 (see FIG. 8) and a second position which results in the mixing blade 234 being disposed in the filter basket 216 (FIG. 9) for mixing the contents of the filter basket during the brewing process. If desired, the knob 320 can also operate an electrical switch (not shown) which can begin the brewing process along with the mixing process. The electrical switch can be electrically connected to a heater/water delivery system of the coffee maker, which begins the brewing process.

The knob 320 attaches to a shaft 322 that is attached to a wheel 324 having a pin 326 extending from the wheel. Movement of the knob 320 from first position (FIG. 8) into the second position (FIG. 9) results in the hub 246 moving downwardly towards the filter basket 216. The mixing blade 234 in the embodiment depicted in FIGS. 8 and 9 also includes the cam surface 276 that cooperates with the lever 278 that is formed in the lid 214. As seen when comparing FIGS. 8 and 9, when the knob 320 is moved into the open position (FIG. 8), the pin 326 engages the interlock mechanism 280 (described below) compressing the spring 282 to allow the cam surface 276 of the mixing blade 234 to move towards the lever 278 to contact the cam surface such that the cam surface rides along the lever and the mixing blade 234 pivots out of the filter basket 216 and towards the rotating hub 246.

The interlock mechanism depicted in FIGS. 8, 8A and 9 precludes the accidental removal of the filter basket 216 from the coffee maker while the mixing blade 234 is disposed inside the filter basket. The knob 320 moves the L-shaped structure 280 that precludes the removal of the filter basket 216 in a direction of arrow A as depicted in FIG. 9. The spring 282 surrounds the shaft 244 and contacts the lid 214 to bias the L-shaped structure 280 downwardly when the knob 320 is in the second (locked) position. The pin 326 engages the interlock mechanism to move it.

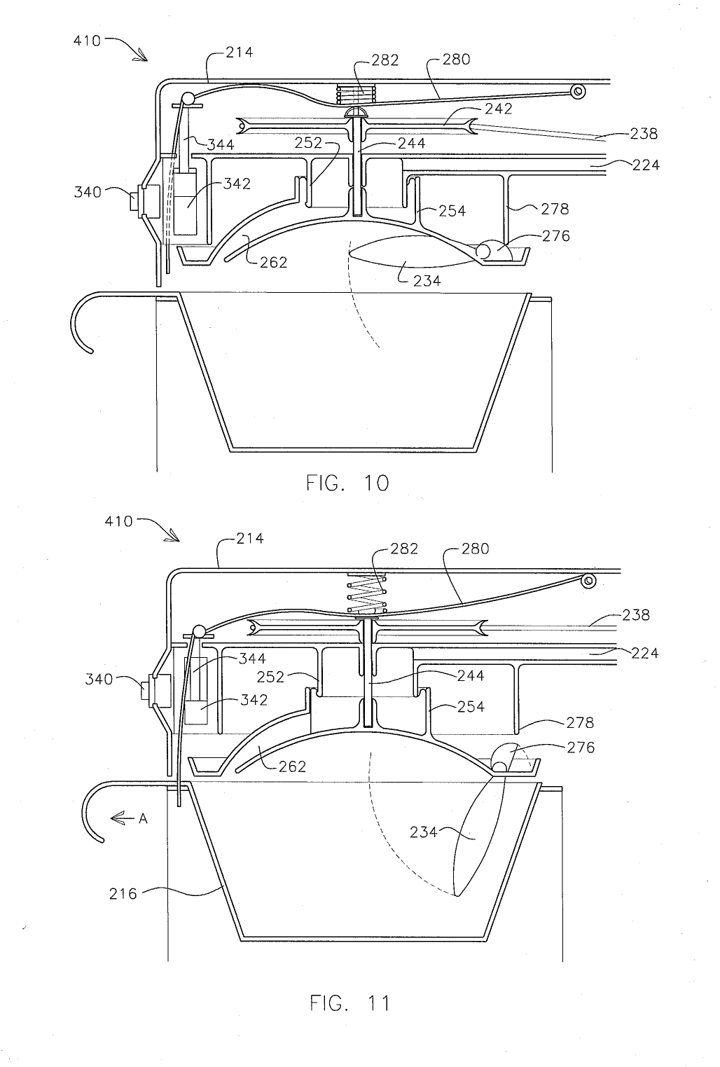

With reference to FIG. 10, a coffee maker 410 includes a housing (not depicted), a lid 214, and a filter basket 216 (FIG. 11). Only a portion of the coffee maker 410 is particularly described since the other components are the same as or very similar to a conventional coffee maker. The coffee maker depicted in FIGS. 10 and 11 includes a solenoid and switch assembly to move the mixing blade 234.

With reference to the embodiment disclosed in FIGS. 10 and 11, a solenoid and switch assembly mounts to the lid 214 and is movable between a first position, which results in the mixing blade 234 being disposed above the filter basket 216 (see FIG. 10) and a second position which results in the mixing blade 234 being disposed in the filter basket 216 (FIG. 11) for mixing the contents of the filter basket during the brewing process. If desired the switch 340 of the assembly can also begin the brewing process along with the mixing process. The switch 340 can be electrically connected to a heater/water delivery system of the coffee maker, which begins the brewing process.

The solenoid 342 actuates an arm 344 to move the L-shaped structure 280, which when in a locked position precludes the removal of the filter basket 216 in a direction of arrow A as depicted in FIG. 11.

Various embodiments of a coffee maker have been described. Various of the above disclosed embodiments and other features and functions, or alternatives thereof, may be desirably combined into many other different applications. Moreover various components from one embodiment can be combined with or replaced for components in another embodiment. Various presently unforeseen or unanticipated alternatives, modifications, variations, or improvements may be subsequently made by those skilled in the art which are also intended to be encompassed by the following claims.

1. A coffee maker comprising:
a filter basket;
a motor;
a hub operatively connected to the motor, the hub configured to rotate about a rotational axis when driven by the motor; and
a mixing blade movably connected to the hub, the mixing blade being movable to a position where the mixing blade is disposed for rotational movement within the filter basket.

2. The coffee maker of claim 1, wherein the mixing blade attaches to the hub at a location offset from the rotational axis of the hub.

3. The coffee maker of claim 1, further comprising a belt driven by the motor, wherein movement of the belt drives the hub.

4. The coffee maker of claim 3, further comprising a pulley driven by the motor, the belt being wrapped around the pulley and the hub, wherein a diameter of the hub is greater than a diameter of the pulley.

5. The coffee maker of claim 3, further comprising a first pulley connected to the motor and a second pulley operatively connected to the hub, the pulleys being surrounded by the belt and the second pulley having a diameter that is greater than a diameter of the first pulley.

6. The coffee maker of claim 1, further comprising means for moving the mixing blade disposed on an exterior surface of the coffee maker.

7. The coffee maker of claim 6, further comprising an interlock mechanism operatively connected to the means for moving the mixing blade, the interlock mechanism being moveable between a first position and a second position, when in the first position the interlock mechanism precludes removal of the filter basket from the coffee maker, when in the second position the interlock mechanism allows removal of the filter basket from the coffee maker.

8. The coffee maker of claim 1, further comprising a housing that receives the filter basket, the housing including a support ledge configured to be at least partially supported by an associated coffee cup, the support ledge including an opening to allow brewed coffee to exit the filter basket en route to the associated coffee cup.

9. The coffee maker of claim 1, further comprising a water distributor having an outlet, the water distributor being operatively connected to the motor.

10. The coffee maker of claim 9, wherein the hub and the water distributor are an integrally molded piece of plastic or metal.

11. The coffee maker of claim 1, wherein the mixing blade is operatively connected to the motor via a transmission that translates rotational movement of the motor into linear or curvilinear movement of the mixing blade.

12. The coffee maker of claim 1, wherein the filter basket is configured to receive at least one of a conventional No. 1 cone filter, a conventional No. 2 cone filter, a conventional No. 4 cone filter, a conventional No. 6 cone filter, a conventional 8-12 cup basket filter, a conventional 30 cup basket filter and a reusable coffee filter.

13. A coffee maker comprising:
a filter basket for holding water and coffee grounds, the filter basket including an outlet through which brewed coffee exits the filter basket;
a mixing assembly for mixing the water and coffee grounds in the filter basket, the mixing assembly comprising a mixing blade and a motor, the mixing blade being operatively connected to the motor such that the motor drives the mixing blade, the mixing blade being located with respect to the filter basket such that the mixing blade moves within the filter basket to mix the water and coffee grounds as the motor drives the mixing blade; and
a frame supporting the filter basket, the frame being configured to be at least partially supported by an associated coffee cup, the frame including an opening to allow brewed coffee to exit the filter basket en route to the associated coffee cup.

14. The coffee maker of claim 13, wherein the frame includes a ring-shaped ledge.

15. The coffee maker of claim 13, wherein the mixing blade is operatively connected to the motor via a transmission that translates rotational movement of the motor into linear or curvilinear movement of the mixing blade.

16. The coffee maker of claim 13, wherein the mixing blade is operatively connected to the motor such that the mixing blade orbits about a central axis of the filter basket.

17. The coffee maker of claim 13, wherein the mixing assembly further includes a hub operatively connected to the motor and the mixing blade attaches to the hub such that the mixing blade is movable with respect to the hub.

18. The coffee maker of claim 17, wherein the mixing blade pivotally attaches to the hub for pivotal movement toward and away from a side wall of the filter basket.

19. The coffee maker of claim 13, wherein the mixing assembly includes a water distributor operatively connected to the motor.

20. The coffee maker of claim 13, further comprising a lid disposed above the filter basket, the lid including an inlet opening, wherein the mixing assembly further includes a hub operatively connected to the motor, the lid being configured such that a majority of the hub is visible through the inlet opening of the lid.

21. The coffee maker of claim 13, further comprising a lid disposed above the filter basket, the lid including an inlet opening in communication with the filter basket and in direct communication with ambient such that a user of the coffee maker can pour water through the inlet into the filter basket.

22. The coffee maker of claim 21, wherein the inlet opening has a diameter that is about equal to a diameter of a conventional coffee cup.

23. The coffee maker of claim 13, wherein the mixing assembly further includes a hub and a belt, the belt operatively connecting the hub to the motor.

24. The coffee maker of claim 13, wherein the mixing blade is made from a flexible material.

25. The coffee maker of claim 13, wherein the frame includes a side wall configured to at least partially surround the filter basket.

26. The coffee maker of claim 25, further comprising electrical contacts, wherein the frame includes a battery compartment, the contacts being disposed in the battery compartment and in electrical communication with the motor.

27. The coffee maker of claim 26, further comprising a recharging jack in electrical communication with the contacts.

28. The coffee maker of claim 25, further comprising a cup selectively received in the frame.

29. The coffee maker of claim 13, wherein the filter basket is configured to receive at least one of a conventional No. 1 cone filter, a conventional No. 2 cone filter, a conventional No. 4 cone filter, a conventional No. 6 cone filter, a conventional 8-12 cup basket filter and a reusable coffee filter.

30. The coffee maker of claim 13, wherein the coffee maker is devoid of a heating element for heating water prior to its entry into the filter basket.

31. A device for making coffee comprising:
a filter basket for holding water and coffee grounds, the filter basket including an outlet through which brewed coffee exits the filter basket;
a motor;
a movable mixing blade operatively connected to the motor and positioned such that the mixing blade moves within the filter basket as the motor is driven; and
a movable water distributor for delivering water to the filter basket, the water distributor operatively connected to the motor and including an outlet that moves as the motor is driven.

32. The device of claim 31, wherein the mixing blade attaches to the water distributor so that the mixing blade rotates along with the outlet of the water distributor.

33. A coffee maker comprising:
a motor;
a mixing blade operatively connected to the motor;
a filter basket, the mixing blade being selectively disposed in the filter basket for movement in the filter basket when being driven by the motor, the filter basket including an inlet that is in communication with ambient vertically above the filter basket to allow an associated user of the coffee maker to pour water into the filter basket while the mixing blade is disposed in the filter basket.

34. The coffee maker of claim 33, wherein the filter basket, the motor and the mixing blade are configured and located with respect to one another to allow an associated user of the coffee maker to pour water into the filter basket from above the filter basket while the mixing blade is being driven by the motor in the filter basket.

35. The coffee maker of claim 33, further comprising a lid disposed on the filter basket, the lid including an opening in communication with the inlet of the filter basket.

36. The coffee maker of claim 35, wherein the opening in the lid has a diameter that is about equal to a diameter of a conventional coffee cup.

37. The coffee maker of claim 33, further comprising a housing and electrical contacts, the housing being connected to the filter basket and including a battery compartment, the electrical contacts being disposed in the battery compartment.

38. The coffee maker of claim 33, further comprising a support ledge connected to the filter basket.

39. The coffee maker of claim 38, further comprising a vertical support member extending from the support ledge away from the filter basket a distance that is greater than a height of a conventional coffee cup.

40. The coffee maker of claim 38, wherein the support ledge is configured to rest on a conventional coffee cup and support the motor, the mixing blade and the filter basket above the coffee cup.

41. The coffee maker of claim 40, wherein the support ledge is ring-shaped.

42. The coffee maker of claim 33, wherein the mixing blade is operatively connected to the motor via a transmission that translates rotational movement of the motor into linear or curvilinear movement of the mixing blade.

43. The coffee maker of claim 33, wherein the mixing blade is operatively connected to the motor such that the mixing blade orbits about a central axis of the filter basket.

44. The coffee maker of claim 33, further comprising a hub operatively connected to the motor, the mixing blade attaches to the hub such that the mixing blade is movable with respect to the hub.

45. The coffee maker of claim 44, wherein the mixing blade pivotally attaches to the hub for pivotal movement toward and away from a side wall of the filter basket.

46. The coffee maker of claim 44, further comprising a belt and a pulley, the pulley being driven by the motor and the belt surrounding the pulley and the hub.

47. The coffee maker of claim 33, wherein the mixing assembly includes a movable water distributor operatively connected to the motor.

48. The coffee maker of claim 33, wherein the coffee maker is devoid of a water heating element.

49. A coffee maker comprising:
a filter basket for holding water and coffee grounds, the filter basket including an outlet through which brewed coffee exits the filter basket;
a mixing assembly for mixing the water and coffee grounds in the filter basket, the mixing assembly comprising a mixing blade and a motor, the mixing blade being operatively connected to the motor such that the motor drives the mixing blade, the mixing blade being selectively located within the filter basket to mix the water and coffee grounds as the motor drives the mixing blade;
a battery compartment connected to the filter basket; and
electrical contacts disposed in the battery compartment, the electrical contacts being in electrical communication with the motor.

50. The coffee maker of claim 49, further comprising a support ledge connected to the filter basket, the support ledge being configured to be at least partially supported by an associated coffee cup, the support ledge including an opening to allow brewed coffee to exit the filter basket en route to the associated coffee cup.

51. The coffee maker of claim 49, wherein the coffee maker is open at its top to allow a user of the coffee maker to pour heated water into the filter basket.

52. The coffee maker of claim 49, wherein the coffee maker does not include a heating element for heating water.

53. The coffee maker of claim 49, further comprising a movable water distributor operatively connected to the motor.

54. The coffee maker of claim 49, further comprising a recharging jack in electrical communication with the contacts.

55. The coffee maker of claim 49, wherein the mixing blade pivots towards and away from the filter basket.
